(19) United States
(12) Patent Application Publication
(10) Pub. No.: US 2005/0065775 A1
(43) Pub. Date: Mar. 24, 2005

(54) Method and system for inputting chinese characters

(76) Inventor: Paul Chi-Sing Poon, San Jose, CA (US)

Correspondence Address: PAUL POON, 1446 ROYAL ANN CT., SAN JOSE, CA, 95129, US

(21) Appl. No.: 10/669,967

(22) Filed: Sep. 23, 2003

(51) Int. Cl. G06F 17/28; G10L 19/00

(52) U.S. Cl. 704/7; 704/201

(57) ABSTRACT

A method and system for inputting Chinese characters from an English keyboard into a computer. The invention is implemented via a software application that runs on a computer to which a physical or virtual keyboard device is connected. The software application has a database of English character sequences each of which is associated with a Chinese character. The software application captures character sequences generated by the user operating the keyboard, and searches its database for matches to the captured sequence.

### BACKGROUND OF THE INVENTION

1. Field of the Invention

This invention relates generally to computer data entry, and more particularly, to a method and system for inputting Chinese characters into a computer. The term Chinese character is used to encompass Traditional Chinese characters as used predominantly in Taiwan, and Simplified Chinese characters, as used predominantly in mainland China.

2. Background Information

Inputting Chinese characters into a computer has always been and continues to be a difficult problem ever since the introduction of computers, due to the large number of unique shapes used in constructing the characters. Over the years, a large number of methods have evolved to solve this problem, but no method managed to solve the conflicting requirements of ease of use and efficiency simultaneously. The present invention is a method with simultaneous improvements in ease of use and efficiency over the prior art.

Chinese Input Methods in the prior art generally fall into one of two broad categories: phonetic or composition, with some hybrids. The present invention falls into the category of composition based methods. Methods in this class assign keyboard keys to represent character components used in constructing Chinese characters. A sequence of keys, likened to an English word, thus represents a series of Chinese character components. Such a series can be compared to a library of series, and the matching one will correspond to a particular Chinese character.

The advantage of composition methods is that it parallels the way Chinese characters are written and is therefore natural to use. However, a major drawback is that there are over 200 frequently occuring components in the language, while the standard computer keyboard only has twenty six keys, making it impossible to assign a unique key to each component. Another serious drawback is the large variety of Chinese character constructs, making it impossible to define a standard rule that can be used to describe how to construct any Chinese character. The present invention creates techniques that overcome these two major drawbacks.

### SUMMARY OF THE INVENTION

The present invention provides a method and system for inputting Chinese characters into a computer. The invention improves the ease of use as well as efficiency of inputting Chinese characters over the prior art. Ease of use and efficiency are inherently conflicting goals in Chinese character input systems.

According to a first aspect of the invention, some of the 200+ components (also called radicals in the literature) used to construct Chinese characters is assigned representation by one of the letters in the English alphabet. This set of selected components is sufficient to construct any Chinese character of interest. Each Chinese character of interest to the present invention is assigned an “encoding”, being a text string in the English language, with each letter of the string corresponding to the Chinese character component as defined by the present invention. This is standard practice in the prior art. In the prior art, the input systems match a given text string against the set of encodings (the library) letter for letter. An input string that matches one in the library selects the Chinese character associated with that encoding. This technique requires the user to accurately memorize the exact encoding assigned to every Chinese character, a monumental task prone to error, confusion, and forgetting from disuse. The present invention uses a novel technique in order to reduce the amount of memorization required of the user. In addition to the set of predefined encodings (the library), the present invention also defines two “equivalence” tables, a “forward” equivalence table and a “backward” equivalence table. These tables define, for each letter of the English alphabet, a set of strings which are to be considered “equivalent” to that letter during a comparison operation. When comparing an input text string against one from the library, the two strings are not simply compared letter for letter. Instead, each letter in the input string is further expanded into the set of predefined strings given by the forward equivalence table. Thus, if the letter ‘a’ is defined in the forward equivalence table as consisting of the set of strings {‘bc’, ‘def’, ‘hijk’}, then the input string “a” will match library strings “a”, “bc”, “def”, and “hijk”. This technique is applied to every letter in an input string. Similarly, the backward equivalence table is applied to all letters in strings defined in the library. Thus, if the letter ‘a’ is defined in the backward equivalence table as equivalent to the set {“zy”, “xwv”, “utsr”}, then a library string “a” will match the input strings “zy”, “xwv”, and “utsr”. The forward and backward equivalence tables are applied in every comparison. The net result is a substantial reduction in the amount of memorization imposed on the user. An example will more clearly illustrate this technique.

For example, the Chinese character [symbol] scan be constructed by using the components “ [symbol] ” and “ [symbol] ”, or the components “ [symbol] ”, “ [symbol] ”, and “ [symbol] ”, or the components “ [symbol] ”, “ [symbol] ”, and “ [symbol] ”, or the components “□”, “-”, and “ [symbol] ”. There is no standard definition as to which composition is the “official” one. In the prior art, the user must provide the exact set of components in the exact sequence as defined by the designer in order to get a match. (Some methods define multiple sequences that map to the same character but that is only done for some characters and still requires exact match of any of the predefined equivalent sequences). This practically requires the user to memorize the exact encoding for every Chinese character. In the present invention, an unlimited number of variations are allowed in describing a character construction to the input method. In the above example, any of the possible descriptions will result in identifying the character. A more detail explanation of how the matches occur follows.

“ [symbol] ” is itself a complete Chinese character, and also a commonly occurring component used in constructing other characters. As a character, it is composed of the components “□” and “-”, and as a component, it is mapped to one of the 26 letters of the English alphabet, say ‘a’. Similarly, “ [symbol] ” is also itself a Chinese character but is not a component used commonly enough in the construction of other characters to warrant assignment to representation by a designated English alphabet. As a character, it is composed of the components “ [symbol] ”, “-”, “ [symbol] ”, “-”, and “-”. Suppose the components “□”, “ [symbol] ”, “ [symbol] ”, and “-” are mapped to the alphabetic letters ‘o’, ‘j’, ‘i’, and ‘h’ respectively. Thus, the character [symbol] can be described by the encoding “ajhihh”, although that's not the only possible encoding, just the one selected by the designer. However, as opposed to the prior art, the user is not required to provide this exact encoding in order to identify the character [symbol] . Instead, as the following table shows, the user can provide any of a number of varying input strings based on what the user perceives as the components of the character [symbol] , which may or may not be the same as what the input method designer has defined:

| Input String | Definition | Result | Reason |
|---|---|---|---|
| ajhihh | ajhihh | match | character for character match |
| aaihh | ajhihh | match | the forward equivalence table |
| | | | defines ‘a’ to be equivalent to ‘jh’. |
| | | | Therefore, the second ‘a’ in input |
| | | | string matches the ‘jh’ in the library |
| | | | enociding string, and the rest match |
| | | | letter for letter |
| ohjhihh | ajhihh | match | the backward equivalence table |
| | | | defines ‘a’ to be equivalent to ‘oh’. |
| | | | Therefore, the ‘oh’ in the input string |
| | | | matches the ‘a’ in the library |
| | | | encoding string, and the rest match |
| | | | letter for letter |
| ohaihh | ajhihh | match | any combination of forward and |
| | | | backward equivalence table |
| | | | matching is allowed. Therefore, ‘oh’ |
| | | | matches ‘a’, and then ‘a’ matches ‘jh’ |

In a second aspect of the present method, a “partial match” algorithm is used to further increase the intelligence of the encoding comparison operation. In addition to allowing one or more “wildcard” characters in a given sequence to match one or more unspecified substring of letters in an encoding, an “implied” wildcard is automatically created by the present invention whenever a given input sequence does not yield any matches. Thus, supposing ‘*’ is a wildcard character, the input sequence “*jhihh” will match the encoding for [symbol] , but “aihh” will also match it. This aspect of the present invention automatically skips over non-matching text runs within an input string while continuing to perform comparisons for matching runs, resulting in a comparison process that accepts partially matching input sequences.

In a third aspect of the present method, a novel way of resolving conflicts among characters having the same encodings is devised. Occasionally, more than one Chinese character are composed of the same exact components, the construction differing only in the relative placement of the components. To resolve these ambiguous encodings, an additional letter with a prescribed semantic of positional description is appended to each conflicting encoding. FIG. 2 contains an example illustrating this novel technique.

In a fourth aspect of the present method, a novel way of selecting characters matched by the input method is devised. Whenever more than one candidate character matches a user given letter sequence, the candidates are presented to the user for a manual selection. In the prior art, a number is sometimes used as a means of specifying the user choice. While a number is obvious in its meaning since a linear list of candidates are offered up for selection, the present invention chooses to use an alphabetic letter instead. Thus, the letter ‘a’ signifies choosing the first candidate, ‘b’ the second, and so forth. The use of an alphabetic letter instead of a number is non-obvious and has never been done in the prior art, as it is not always possible for any given input method since the alphabetic letters are used for encoding Chinese characters and may confuse the system if also used as candidate selection keys. This aspect of the present invention is significant in that it allows the user to keep his fingers on the basal touch typing position (as opposed to having to move them away to type a number), resulting in faster typing speed.

In a fifth aspect of the present method, a novel way of attaching additional information to an input string is devised. Since the present invention only employs the 26 lower case alphabetic letters in constructing input sequences, letters outside of the employed set can be and are used as carriers of additional information about the input sequence. For example, the input sequence “abc6-9” is interpreted to mean ‘match all characters defined by the encoding “abc” and with a stroke count of 6 to 9’. Another example is any input sequence beginning with an uppercase letter is defined to mean “pass through”, which means the given input sequence is made the output without interpretation, creating an efficient way of entering English sentences in the midst of Chinese characters.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a list of strokes, stroke sequences, or radicals represented by each key on a common English keyboard, suitable to implement the invention;

FIG. 2 is a number of example encodings of certain characters, along with explanation of how the encoding is arrived at, as well as variations of the encoding that also identifies the same character;

FIG. 3 is a system diagram showing one embodiment of the invention implemented as a computer program running on a personal computer;

FIG. 4 is a screen shot of one implementation of one embodiment of the present invention illustrating how the invention can be used in a real product;

FIG. 5 is a sample “backward equivalence table” as described in the present invention and used in the above embodiment implementation;

FIG. 6 is a sample “forward equivalence table” as described in the present invention and used in the above embodiment implementation;

### DETAILED DESCRIPTION OF THE ILLUSTRATED EMBODIMENTS

The present invention provides a method and system for efficiently inputting Chinese characters into a device which has the ability to store encodings representing characters used in a language, such as a personal computer, a handheld computer, or any other such electronic equipment, using a standard English language based keyboard. The following description is presented to enable one of ordinary skill in the art to make and use the invention and is provided in the context of exemplary preferred embodiments. Various modifications to the preferred embodiments will be readily apparent to those skilled in the art and the generic principles defined herein may be applied to other embodiments. Thus, the present invention is not intended to be limited to the embodiments shown herein, but is to be accorded a scope consistent with the principles and features described herein.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Exemplary Computer System for Implementing the Invention

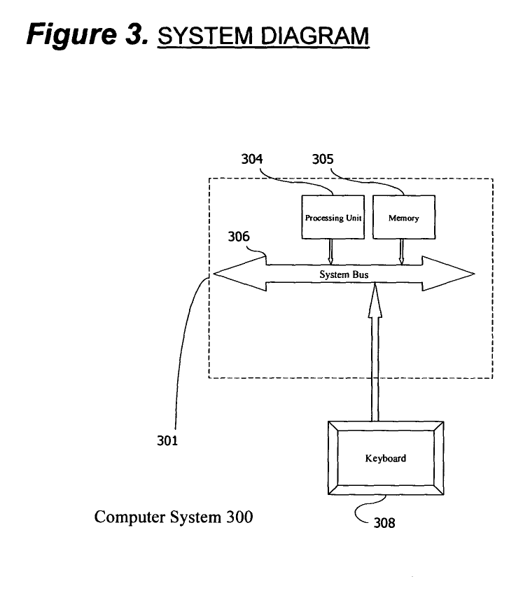

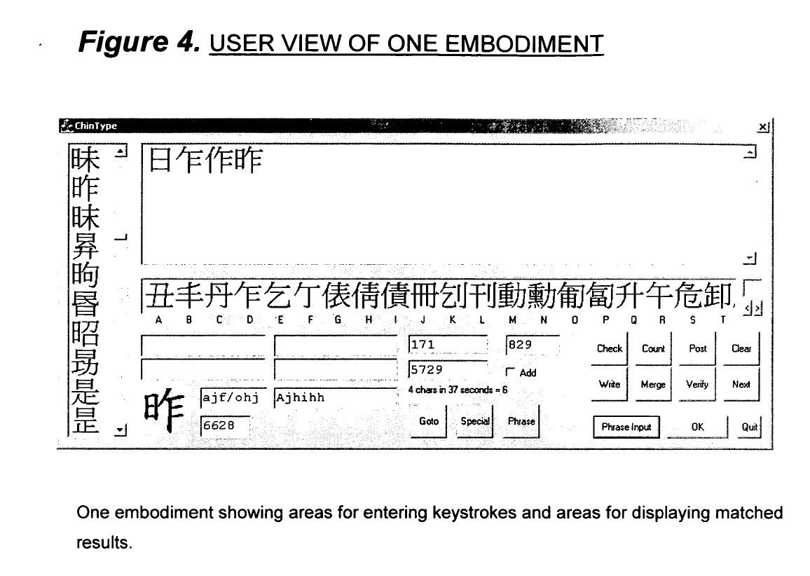

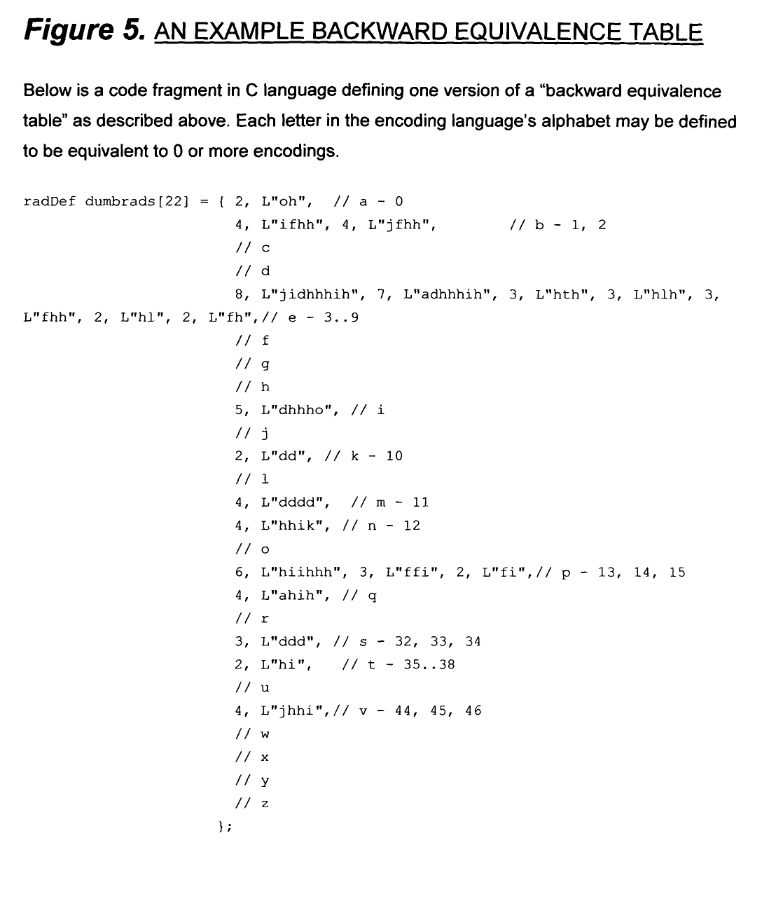

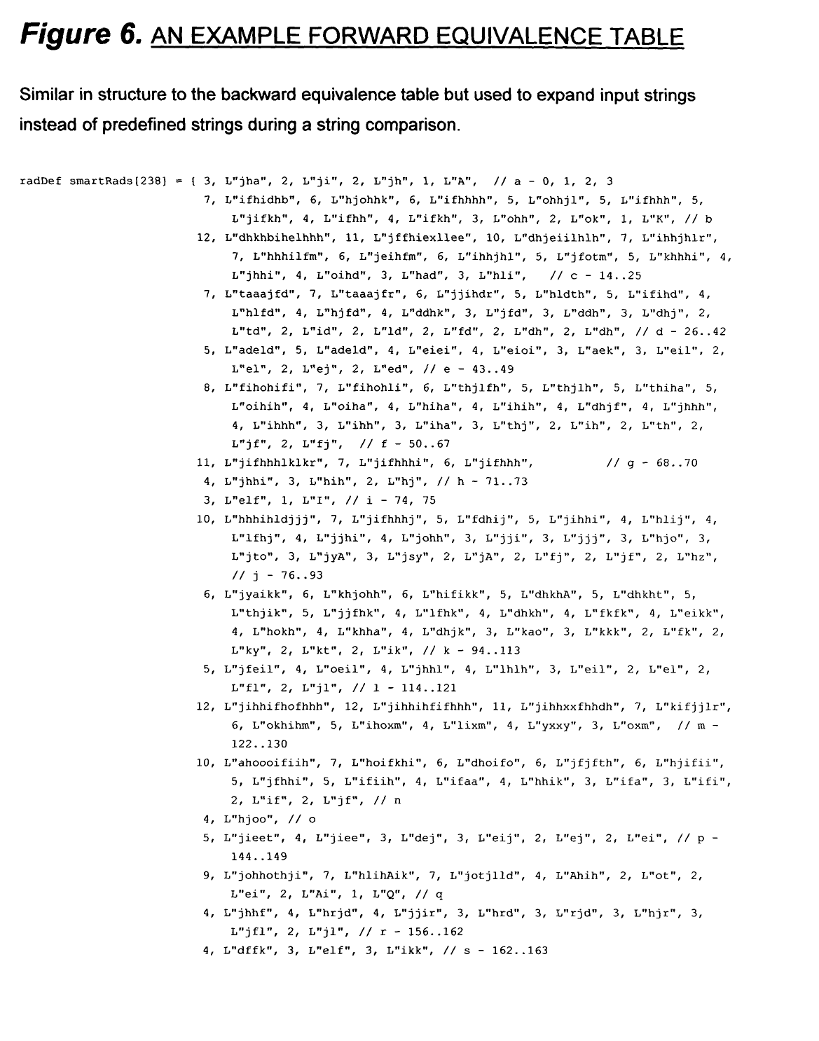

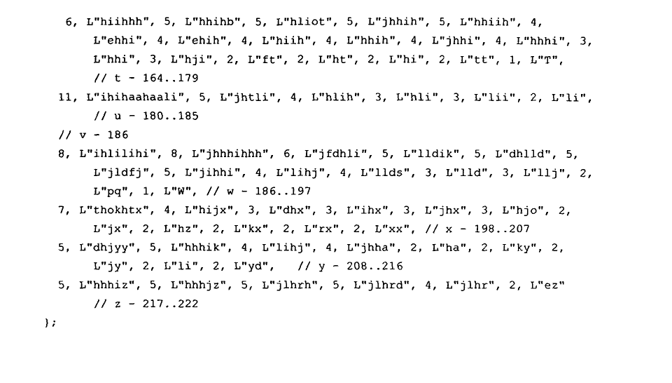

In accord with the present invention, a person (the user), desiring to enter Chinese characters into a computer, starts a computer program which is one embodiment of the present invention, and incorporating in it a database of predefined encodings corresponding to Chinese characters. This computer program typically resides on a personal computer, which has installed on it a keyboard depicting the letters a through z. FIG. 3 shows a typical computer set up for use by such a program, which is a suitable computing environment in which the invention may be implemented.

Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, specialized hardware devices, network processes, minicomputers, mainframe computers, and the like. The invention may also be practiced in distributed computing environments where tasks are performed by remote processing devices that are linked through a communications network. In a distributed computing environment, program modules may be located in both local and remote memory storage devices.

With reference to FIG. 3, an exemplary system 300 for implementing the invention includes a general purpose computing device in the form of a conventional personal computer 301 comprising a processing unit 304 for processing program and/or module instructions, a memory 305 in which the program and/or module instructions may be stored, a system bus 306, and other system components, such as storage devices, which are not shown but will be known to those skilled in the art. The system bus serves to connect various components to processing unit 304, so that the processing unit can act on the data coming from such components, and send data to such components. For instance, system 300 may include a keyboard 308 that is used to collect text entered by the user. In the context of the following discussion, the keyboard 308 is described as a stand-alone component. It will be understood that the functionality provided by such keyboard may be facilitated by both a stand-alone hardware device, or a virtual device simulating the functions of such hardware device.

System Architecture

In one embodiment, the present invention may be implemented as a computer program running on a personal computer. When the user desires to enter Chinese characters into the computer's input stream, the user first activates the program implementing the invention. Upon activation, this program watches incoming key presses from the keyboard. Each key pressed by the user is read and stored into a buffer, in the order received, until a certain designated key, such the space bar, is pressed, signaling the end of one character identification sequence. The program then compares the completed input sequence with a database of predefined sequences representing Chinese characters, using any of a number of search algorithms published in the prior art such as serial search, quick search, indexed search, hashing, and so on, along with specific matching techniques described in the present invention. If one and only one exact match is found, the Chinese character thus defined is sent to the computer's input stream. If more than one match is found, multiple characters are presented to the user for manual selection. If no match is found, no character is sent. In all cases, entering the designated ‘end sequence’ character terminates one sequence and simultaneously starts the next one, repeating the above process all over again. This process continues until the user presses a key to disarm the program, or terminates it outright.

Although the present invention has been described in connection with a preferred form of practicing it and modifications thereto, those of ordinary skill in the art will understand that many other modifications can be made to the invention within the scope of the claims that follow. Accordingly, it is not intended that the scope of the invention in any way be limited by the above description, but instead be determined entirely by reference to the claims that follow.

1. In a Chinese character input method wherein Chinese characters are defined as key sequences and selected by matching a given sequence against the set of predefined sequences, wherein the improvement comprises sequence comparison method in which a key or consecutive run of keys from one sequence is considered a match to a key or consecutive run of keys in the other sequence in accordance with a predefined mapping of keys and runs of keys.

2. The method of claim 1, further comprising a method of comparing a given sequence to a predefined one wherein, without the use of a designated ‘wildcard’ symbol, a match is achieved when the given sequence only matches parts of the predefined sequence.

3. The method of claim 1, further comprising a method of encoding Chinese characters as text strings of another language wherein certain letters used in an encoding are defined to carry certain positional information relating to the components of the Chinese character represented by the encoding.

4. The method of claim 1, further comprising a method of specifying a Chinese character encoding as a text string of another language wherein certain letters present in the specifying string are defined to bear special instructions for the method of claim 1.

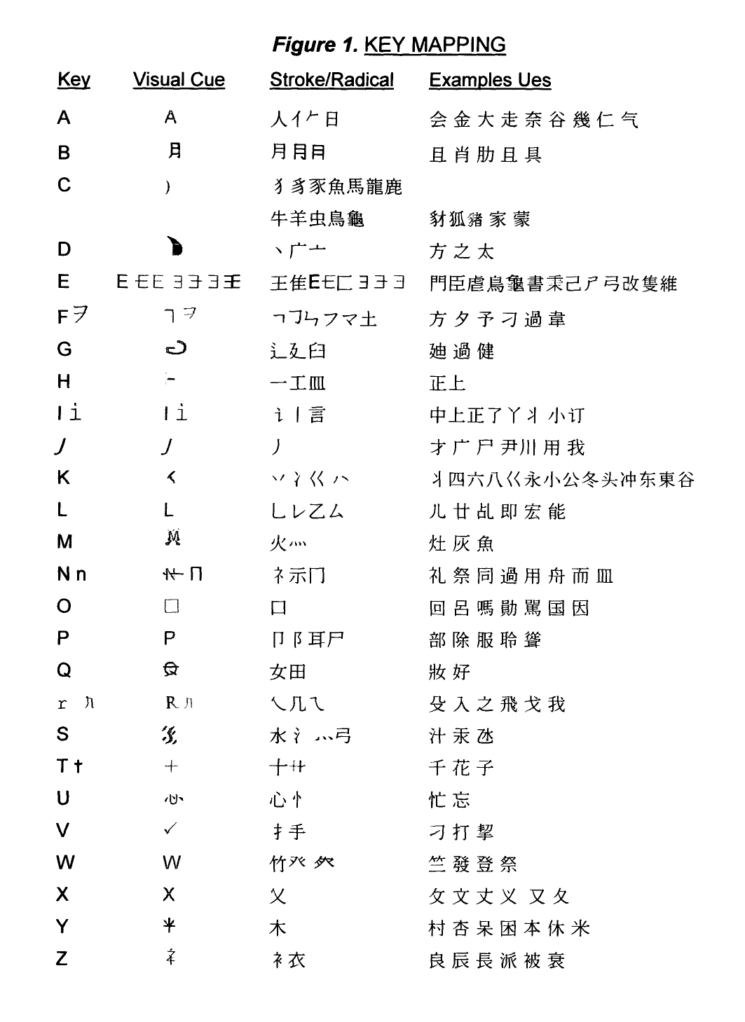

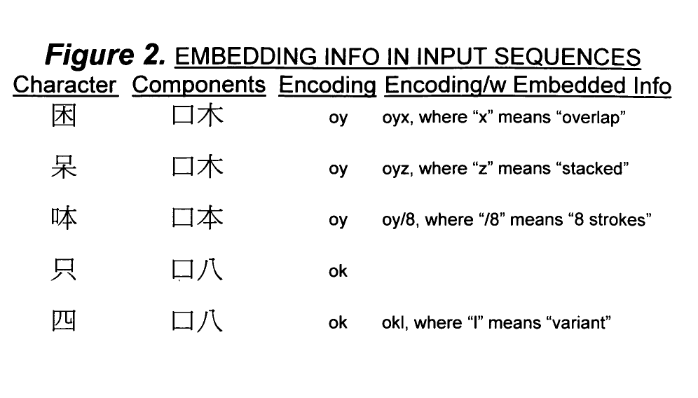

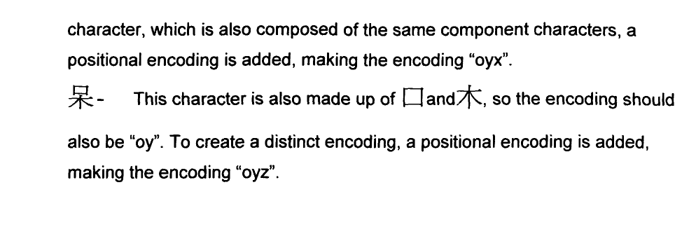

5. The method of claim 1, further comprising defining each letter of the English alphabet as a representation of one or more Chinese language strokes, stroke combinations, or radicals, as depicted in FIG. 1.

6. The method of claim 1, further comprising a selection technique whereby a set of candidate characters is displayed for user selection by the user entering a symbol which serves as an identifier of the desired candidate wherein the set of identifier symbols overlaps the set of symbols used in defining the Chinese characters themselves, including the character(s) used as termination of the definitions.

7. In a Chinese character input method wherein Chinese characters are defined as key sequences and are selected based on matching a given sequence to the set of predefined sequences, wherein the improvement comprises a character identification method in which certain strokes and components of the Chinese written language are respectively mapped to certain keys, and in which a Chinese character is identifiable by a plurality of key sequences whereas the plurality arises as a result of specifying certain component(s) contained in the character either as a single key representing the component, or as a sequence of keys representing the constituent strokes and components of the component.
